(19) United States
(12) Patent Application Publication
(10) Pub. No.: US 2025/0277386 A1
(43) Pub. Date: Sep. 4, 2025

(54) SUCTION POOL CLEANER

(71) Applicant: NINGBO POOLSTAR POOL PRODUCTS CO.,LTD., Ningbo (CN)

(72) Inventor: Liang CHEN, Ningbo (CN)

(21) Appl. No.: 19/212,526

(22) Filed: May 19, 2025

(30) Foreign Application Priority Data
Jan. 22, 2025 (CN) 202520156637.3

(51) Int. Cl. E04H 4/16; B01D 29/56; B01D 29/90; C02F 1/00; C02F 103/42; F04D 1/00; F04D 29/22; F04D 29/70

(52) U.S. Cl. CPC E04H 4/1636; B01D 29/56; B01D 29/90; C02F 1/001; F04D 1/00; F04D 29/2288; F04D 29/708; C02F 2103/42

(57) ABSTRACT

A suction pool cleaner, including a shell assembly, a first filtering assembly, an impeller assembly and a second filtering assembly. The shell assembly includes a first shell, a second shell and a third shell communicated in sequence. An end of the first shell away from the second shell has an inlet. An end of the third shell away from the second shell has an outlet. The first filtering assembly is provided within the first shell for primary filtration of wastewater. The impeller assembly is provided within the second shell, and is adjacent to the first filtering assembly. The impeller assembly can generate a suction force to suck the wastewater and a centrifugal force to discharge the primarily-treated water. The second filtering assembly is provided within the third shell for secondary filtration of the water discharged from the impeller assembly.

### CROSS-REFERENCE TO RELATED APPLICATIONS

This application claims the benefit of priority from Chinese Patent Application No. 202520156637.3, filed on Jan. 22, 2025. The content of the aforementioned application, including any intervening amendments made thereto, is incorporated herein by reference in its entirety.

### TECHNICAL FIELD

This application relates to pool cleaners, and more particularly to a suction pool cleaner.

### BACKGROUND

An operation principle of the existing suction pool cleaners is similar to that of a water pump. Specifically, the impeller is driven by a motor to rotate at a high speed, so as to generate a centrifugal force; as the water flows from the channel of the dirt suction chamber to the impeller, it will be thrown towards outlets distributed around the impeller, creating a vacuum condition at the impeller; and under the action of the pressure difference, water as well as debris (e.g., sand and leaves) is sucked from the pool into the suction chamber. A core part of the suction pool cleaner is composed of the suction chamber, a motor chamber and the impeller arranged vertically. The suction chamber is located at an end of the cleaner. The impeller is provided between the suction chamber and the motor chamber, and is connected to an output shaft of the motor. A filter is provided at a front end of the suction chamber. The motor chamber includes the motor, wiring and a switch. Several drainage holes are provided around the impeller. During operation, water and debris enter the suction chamber through an opening, and pass through a filter assembly, where the debris is retained. The filtered water then exits through the drainage holes around the impeller.

At present, most of the commercially-available suction pool cleaners rely on the suction force to draw debris and waste from the water surface into the cleaner, and this method can only achieve the preliminary cleaning. Moreover, the single suction device fails to achieve the effective filtration of finer debris and other small contaminants, failing to optimally improve the water quality. In addition, the existing suction pool cleaners generally suffer from limited storage capacity for collected debris, and thus it is required to frequently transfer the collected debris, which increases maintenance costs and operation complexity.

### SUMMARY

An object of the disclosure is to provide a suction pool cleaner to overcome the defects in the prior art.

Technical solutions of the present disclosure are described as follows.

A suction pool cleaner, comprising:
a shell assembly;
a first filtering assembly;
an impeller assembly; and
a second filtering assembly;
wherein the shell assembly comprises a first shell, a second shell and a third shell communicated in sequence;
the third shell is provided on a side of the second shell; an end of the first shell away from the second shell is provided with an inlet;
an end of the third shell away from the second shell is provided with an outlet;
the first filtering assembly is provided within the first shell, and is configured to perform filtration on raw water from a pool;
the impeller assembly is provided within the second shell, and is adjacent to the first filtering assembly; and the impeller assembly is configured to generate a suction force to suck the raw water from the pool, and generate a centrifugal force to output water treated by the first filtering assembly to the second filtering assembly; and
the second filtering assembly is provided within the third shell, and is configured to perform filtration on the water output from the impeller assembly.

In some embodiments, the shell assembly further comprises a guide pipe; and an end of the guide pipe is integrally formed at the inlet.

In some embodiments, the impeller assembly comprises an impeller and a driving part; the impeller and the driving part are provided within the second shell; the driving part comprises a rotating shaft; and the impeller is provided at the rotating shaft; and
the driving part is configured to drive the impeller to rotate around an axis of the rotating shaft to generate the suction force and the centrifugal force.

In some embodiments, the shell assembly further comprises a fourth shell provided within the second shell; the fourth shell is configured to divide an interior of the second shell into a first accommodating chamber and a second accommodating chamber; the first accommodating chamber is communicated with the first shell and the third shell; the impeller is provided within the first accommodating chamber; the driving part is provided within the second accommodating chamber; and the rotating shaft is configured to pass through the fourth shell to be connected to the impeller.

In some embodiments, the suction pool cleaner further comprises a mounting part;
wherein the mounting part is provided within the first accommodating chamber, and is connected to the fourth shell; and the impeller is provided within the mounting part.

In some embodiments, the impeller comprises an impeller shaft and a plurality of blades; the impeller shaft is sleeved on the rotating shaft; and the plurality of blades are arranged around the impeller shaft.

In some embodiments, each of the plurality of blades is streamlined in shape.

In some embodiments, the shell assembly further comprises a connecting part; and the connecting part is provided between the first shell and the second shell.

In some embodiments, the first shell is detachably connected to the connecting part; and the third shell is detachably connected to the second shell.

In some embodiments, the first filtering assembly comprises a filter mesh cover and a fixing part; and the filter mesh cover is fixedly provided within the first shell through the fixing part.

Compared to the prior art, the present disclosure has the following beneficial effects.

By means of the rotation of the impeller assembly, the suction pool cleaner provided herein continuously draws wastewater containing debris into the first shell through the inlet. The first filtering assembly filters out larger debris within the first shell. The primarily-treated water is then forced by a centrifugal force generated by the impeller assembly to flow into the third shell, and undergoes a secondary filtration by the second filtering assembly. The second filtering assembly further captures residual contaminants from the water discharged from the impeller assembly, allowing the purified water to flow out through gaps in the second filtering assembly, thereby achieving a cleaning effect. By providing the first filtering assembly and the second filtering assembly, the wastewater is subjected to two-stage filtration, thereby improving the overall cleaning effect. Furthermore, the first shell and the third shell are arranged to collect and store debris and contaminants, effectively increasing the debris-holding capacity of the suction pool cleaner.

### BRIEF DESCRIPTION OF THE DRAWINGS

In order to illustrate the technical solutions in the embodiments of the present disclosure or the prior art more clearly, the accompanying drawings needed in the description of the embodiments or prior art will be briefly described below. Obviously, presented in the accompanying drawings are only some embodiments of the present disclosure, and for those of ordinary skill in the art, other accompanying drawings can be obtained from the structures illustrated therein without making creative effort.

FIG. 1 is a structural diagram of a suction pool cleaner according to an embodiment of the present disclosure;

FIG. 2 is a sectional view of the suction pool cleaner according to an embodiment of the present disclosure;

FIG. 3 is a sectional perspective view of the suction pool cleaner according to an embodiment of the present disclosure;

FIG. 4 is a structural diagram of a mounting part according to an embodiment of the present disclosure;

FIG. 5 is a structural diagram of an impeller according to an embodiment of the present disclosure;

FIG. 6 is a sectional view of the impeller according to an embodiment of the present disclosure; and

FIG. 7 is a structural diagram of a first filtering assembly according to an embodiment of the present disclosure.

In the figures: 1—shell assembly; 11—first shell; 12—second shell; 13—third shell; 14—first inlet; 15—first outlet; 16—guide pipe; 17—fourth shell; 18—first accommodating chamber; 19—second accommodating chamber; 2—first filtering assembly; 21—filter mesh cover; 22—fixing part; 3—impeller assembly; 31—impeller; 32—driving part; 321—rotating shaft; 33—impeller shaft; 34—blade; 35—first cover plate; 36—second cover plate; 37—second inlet; 38—second outlet; 39—connecting portion; 391—rotating shaft hole; 4—mounting part; 41—opening; and 5—connecting part.

The implementation, functional characteristics and advantages of the present disclosure will be further described in conjunction with the embodiments and accompanying drawings.

### DETAILED DESCRIPTION OF EMBODIMENTS

The technical solutions in the embodiments of the present disclosure will be described clearly and completely below in conjunction with the accompanying drawings. It is obvious that the described embodiments are merely some embodiments of the present disclosure, instead of all embodiments. Based on the embodiments in the present disclosure, all other embodiments obtained by those of ordinary skill in the art without making creative effort shall fall within the scope of the present disclosure.

It should be noted that all directional indications (such as up, down, left, right, front, and back) are used only for explaining the relative positional relationship or movement between the components in a particular attitude (as shown in the accompanying drawings), and the directional indications are correspondingly changed if the particular attitude is changed.

As used herein, terms such as “first” and “second” are only descriptive, and should not be construed as indicating or implying their relative importance or implicitly specifying the number of technical features indicated. As a result, a feature defined as “first” or “second” may include at least one of such feature, either explicitly or implicitly. In addition, “and/or” includes three solutions, for example, “A and/or B” includes technical solution A, technical solution B, and a combination thereof. In addition, the technical solutions of various embodiments may be combined with each other on the premise that the combined solution can be implemented by those of ordinary skill in the art. When the combination of technical solutions appears to be contradictory or unimplementable, it should be understood that such a combination does not exist and is not included within the scope of the present disclosure.

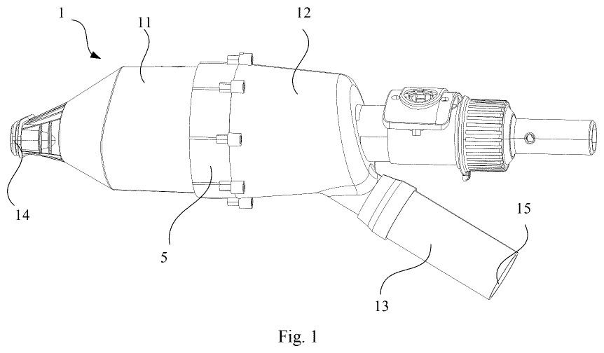

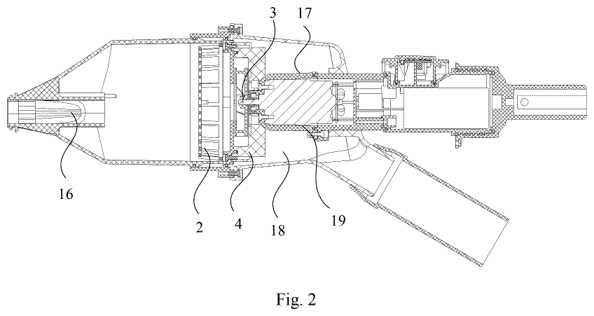

As shown in FIGS. 1-2, an embodiment of the present disclosure provides a suction pool cleaner, including a shell assembly 1, a first filtering assembly 2, an impeller assembly 3 and a second filtering assembly. The shell assembly 1 includes a first shell 11, a second shell 12 and a third shell 13 communicated in sequence. The third shell 13 is provided on a side of the second shell 12. An end of the first shell 11 away from the second shell 12 is provided with a first inlet 14. An end of the third shell 13 away from the second shell 12 is provided with a first outlet 15. The first filtering assembly 2 is provided within the first shell 11, and is configured to perform filtration on raw water from a pool. The impeller assembly 3 is provided within the second shell 12, and is adjacent to the first filtering assembly 2. The impeller assembly 3 is configured to generate a suction force to suck the raw water from the pool, and generate a centrifugal force to output water treated by the first filtering assembly 2 to the second filtering assembly. The second filtering assembly is provided within the third shell 13, and is configured to perform filtration on the water output from the impeller assembly 3.

By means of the rotation of the impeller assembly 3, the suction pool cleaner provided herein continuously draws wastewater containing debris into the first shell 11 through the first inlet 14. The first filtering assembly 2 filters out larger debris within the first shell 11. The primarily-treated water is then driven into the third shell 13 by a centrifugal force generated by the impeller assembly 3, where it undergoes a secondary filtration by the second filtering assembly. The second filtering assembly further captures residual contaminants from the water discharged from the impeller assembly 3, allowing the purified water to flow out through gaps in the second filtering assembly, thereby achieving a cleaning effect. By providing the first filtering assembly 2 and the second filtering assembly, the wastewater is subjected to two-stage filtration, thereby improving the overall cleaning effect. Furthermore, the first shell 11 and the third shell 13 are arranged to collect and store debris and contaminants, effectively increasing the debris-holding capacity of the suction pool cleaner.

As shown in FIGS. 1-2, the shell assembly 1 further includes a guide pipe 16. An end of the guide pipe 16 is integrally formed at the first inlet 14.

Specifically, the guide pipe 16 is provided at the first inlet 14, and is configured to bend and extend inwardly. A first debris chamber is formed between an outer side wall of the guide pipe 16 and an inner side wall of the first shell 11. The first debris chamber is configured to receive larger debris contained in the wastewater. An interior of the third shell 13 is configured as a second debris chamber, and the second debris chamber is configured to collect smaller debris contained in the wastewater.

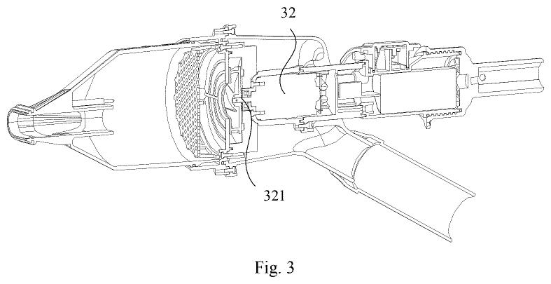

As shown in FIGS. 2-5, the impeller assembly 3 includes an impeller 31 and a driving part 32. The impeller 31 and the driving part 32 are provided within the second shell 12. The driving part 32 includes a rotating shaft 321. The impeller 31 is provided at the rotating shaft 321. The driving part 32 is configured to drive the impeller 31 to rotate around an axis of the rotating shaft 321 to generate the suction force and the centrifugal force.

In this embodiment, the driving part 32 is a motor.

As shown in FIGS. 1-3, the shell assembly 1 further includes a fourth shell 17 provided within the second shell 12. The fourth shell 17 is configured to divide an interior of the second shell 12 into a first accommodating chamber 18 and a second accommodating chamber 19. The first accommodating chamber 18 is communicated with the first shell 11 and the third shell 13. The impeller 31 is provided within the first accommodating chamber 18. The driving part 32 is provided within the second accommodating chamber 19. The rotating shaft 321 is configured to pass through the fourth shell 17 to be connected to the impeller 31.

Specifically, an interior of the fourth shell 17 is sealed to prevent wastewater from entering the fourth shell 17, thereby avoiding damage to electronic components.

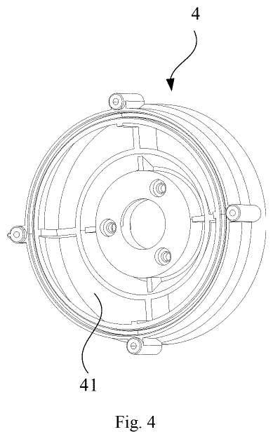

As shown in FIGS. 1 and 4, the suction pool cleaner further includes a mounting part 4. The mounting part 4 is provided within the first accommodating chamber 18, and is connected to the fourth shell 17. The impeller 31 is provided within the mounting part 4.

Specifically, the impeller 31 is provided at a middle portion of the mounting part 4. The mounting part 4 is provided with an opening 41 configured to surround the impeller 31. Wastewater is driven by the centrifugal force generated during the rotation of the impeller 31 toward the opening 41, and then flows into the third shell 13.

Furthermore, the opening 41 is provided in plurality, and a plurality of openings 41 are arranged around an axial center of the mounting part 4.

Specifically, the mounting part 4 is fixedly connected to the fourth shell 17 by screws. The rotating shaft 321 is configured to pass through the fourth shell 17 and the mounting part 4 to be connected to the impeller 31.

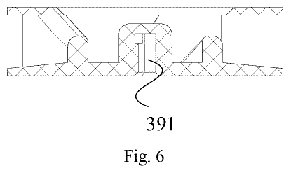

As shown in FIGS. 1, 5, and 6, the impeller 31 includes an impeller shaft 33 and a plurality of blades 34. The impeller shaft 33 is sleeved on the rotating shaft 321. The plurality of blades 34 are arranged around the impeller shaft 33.

Specifically, the impeller shaft 33 includes a first cover plate 35 and a second cover plate 36. The plurality of blades 34 are arranged between the first cover plate 35 and the second cover plate 36. A center of the first cover plate 35 is provided with a second inlet 37. An edge of the second inlet 37 is streamlined to reduce water intake resistance and improve the efficiency of the plurality of blades 34. A second outlet 38 is formed between the first cover plate 35, the second cover plate 36 and the plurality of blades 34. A bottom surface of the second outlet 38, i.e., a portion where the second outlet 38 is provided on the second cover plate 36, is configured as an inclined surface. This configuration helps reduce water outlet resistance and lowers the radial force acting on the impeller 31, thereby extending the service life of the impeller 31 and reducing the motor energy consumption.

Furthermore, the impeller 31 further includes a connecting portion 39 provided on a top surface of the second cover plate 36. A middle portion of the connecting portion 39 is provided with a rotating shaft hole 391, and the rotating shaft hole 391 is configured to pass through the second cover plate 36. The rotating shaft 321 of the driving part 32 is configured to pass through the rotating shaft hole 391 to be connected to the impeller 31.

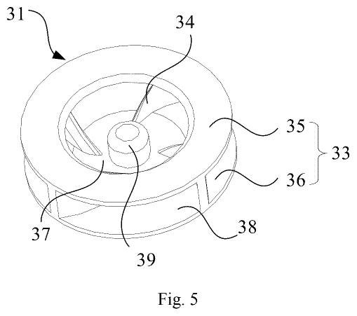

As shown in FIG. 5, each of the plurality of blades 34 has an overall streamlined shape, which helps reduce the flow resistance acting on it.

As shown in FIG. 1, the shell assembly 1 further includes a connecting part 5, and the connecting part 5 is provided between the first shell 11 and the second shell 12.

Specifically, a first end of the connecting part 5 is detachably connected to the first shell 11, a second end of the connecting part 5 is fixedly connected to a first end of the second shell 12, and a second end of the second shell 12 is detachably connected to the third shell 13.

In this embodiment, the connecting part 5 is threadedly connected to the first shell 11 to facilitate disassembly of the first shell 11 for disposing of the debris contained in the first debris chamber. The connecting part 5 is fixedly connected to the first end of the second shell 12 by screws. The second end of the second shell 12 is threadedly connected to an end of the third shell 13, thereby facilitating disassembly for disposing of the debris contained in the second debris chamber.

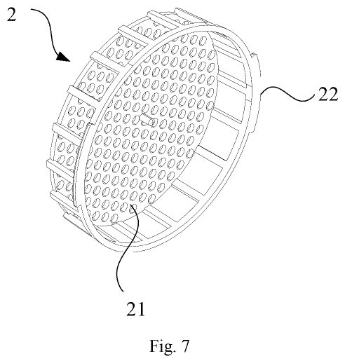

As shown in FIG. 7, the first filtering assembly 2 includes a filter mesh cover 21 and a fixing part 22. The filter mesh cover 21 is fixedly provided within the first shell 11 through the fixing part 22.

Specifically, the filter mesh cover 21 and the fixing part 22 are integrally formed. The fixing part 22 is in a snap-fit connection with the first shell 11.

In an embodiment, the third shell 13 is configured as a connecting joint. The second filtering assembly is configured as a filter mesh bag sleeved around an outer portion of the first outlet 15 of the third shell 13. Specifically, an aperture size of the first filtering assembly 2 is greater than that of the second filtering assembly, such that the first filtering assembly 2 filters out larger debris contained in the wastewater, while the second filtering assembly filters out smaller debris contained in the wastewater.

In an embodiment, the third shell 13 is a plastic shell. The second filtering assembly is a filter screen embedded within the third shell 13.

In an embodiment, the third shell 13 is a plastic mesh cover. The second filtering assembly is a filter ball within the third shell 13.

Described above are merely preferred embodiments of the present disclosure, and are not intended to limit the scope of the present disclosure. It should be understood that various modifications, changes and replacements made by those skilled in the art without departing from the spirit of the disclosure shall fall within the scope of the present disclosure defined by the appended claims.

What is claimed is:

1. A suction pool cleaner, comprising:
a shell assembly;
a first filtering assembly;
an impeller assembly; and
a second filtering assembly;
wherein the shell assembly comprises a first shell, a second shell and a third shell communicated in sequence;
the third shell is provided on a side of the second shell; an end of the first shell away from the second shell is provided with an inlet;
an end of the third shell away from the second shell is provided with an outlet;
the first filtering assembly is provided within the first shell, and is configured to perform filtration on raw water from a pool;
the impeller assembly is provided within the second shell, and is adjacent to the first filtering assembly; and the impeller assembly is configured to generate a suction force to suck the raw water from the pool, and generate a centrifugal force to output water treated by the first filtering assembly to the second filtering assembly; and
the second filtering assembly is provided within the third shell, and is configured to perform filtration on the water output from the impeller assembly.

2. The suction pool cleaner according to claim 1, wherein the shell assembly further comprises a guide pipe; and an end of the guide pipe is integrally formed at the inlet.

3. The suction pool cleaner according to claim 1, wherein the impeller assembly comprises an impeller and a driving part; the impeller and the driving part are provided within the second shell; the driving part comprises a rotating shaft; and the impeller is provided at the rotating shaft; and
the driving part is configured to drive the impeller to rotate around an axis of the rotating shaft to generate the suction force and the centrifugal force.

4. The suction pool cleaner according to claim 3, wherein the shell assembly further comprises a fourth shell provided within the second shell; the fourth shell is configured to divide an interior of the second shell into a first accommodating chamber and a second accommodating chamber; the first accommodating chamber is communicated with the first shell and the third shell; the impeller is provided within the first accommodating chamber; the driving part is provided within the second accommodating chamber; and the rotating shaft is configured to pass through the fourth shell to be connected to the impeller.

5. The suction pool cleaner according to claim 4, further comprising:
a mounting part;
wherein the mounting part is provided within the first accommodating chamber, and is connected to the fourth shell; and the impeller is provided within the mounting part.

6. The suction pool cleaner according to claim 5, wherein the impeller comprises an impeller shaft and a plurality of blades; the impeller shaft is sleeved on the rotating shaft; and the plurality of blades are arranged around the impeller shaft.

7. The suction pool cleaner according to claim 6, wherein each of the plurality of blades is streamlined in shape.

8. The suction pool cleaner according to claim 1, wherein the shell assembly further comprises a connecting part; and the connecting part is provided between the first shell and the second shell.

9. The suction pool cleaner according to claim 8, wherein the first shell is detachably connected to the connecting part; and the third shell is detachably connected to the second shell.

10. The suction pool cleaner according to claim 1, wherein the first filtering assembly comprises a filter mesh cover and a fixing part; and the filter mesh cover is fixedly provided within the first shell through the fixing part.
